(19) United States
(12) Patent Application Publication
(10) Pub. No.: US 2012/0003744 A1
(43) Pub. Date: Jan. 5, 2012

(54) DIAGNOSTIC METHODS

(75) Inventors: Shahid Mian, Nottingham (GB); Kevin Slater, Nottingham (GB)

(73) Assignee: PETSCREEN LIMITED, Nottingham, Nottinghamshire (GB)

(21) Appl. No.: 12/673,060

(22) PCT Filed: Aug. 11, 2008
(86) PCT No.: PCT/GB2008/050692

§ 371 Date: Feb. 11, 2010

Related U.S. Application Data
(60) Provisional application No. 60/935,457, filed on Aug. 14, 2007.

(51) Int. Cl. G01N 30/96; G01N 30/90

(52) U.S. Cl. 436/64; 436/86

(57) ABSTRACT

The present invention provides a method for identifying a biomarker for diagnosis of lymphoma in a canine subject. The method comprises the following steps: (i) providing serum samples from canine subjects with lymphoma (lymphoma samples); (ii) providing serum samples from canine subjects free from lymphoma (control samples); (iii) fractionating the protein components in the serum samples provided in steps (i) and (ii) using anion exchange chromatography; (iv) further purifying proteins from the fractionated samples produced in step (iii) by contacting the proteins therein with a SELDI protein chip comprising a cation exchange surface; (v) characterising the proteins adhered to the cation exchange surface of the SELDI protein chip in step (iv) using mass spectrometry; and (vi) performing a classification and regression tree (CART) analysis to identify proteins capable of acting as biomarkers, either alone or in combination with other proteins. The invention further provides biomarkers for use in the diagnosis of canine lymphoma and methods of diagnosis using the same.

The invention relates to methods of diagnosis of lymphoma in canine subjects, and to identification of biomarkers for use in the same.

Cancer is a major cause of morbidity and mortality within canines globally, with approximately one in four dogs being clinically diagnosed at some point in their life. Lymphoma is responsible for approximately 20% of all canine cancers and so the detection of biomarkers associated with disease will be of paramount importance not only for disease detection but also as potential markers of disease progression and disease response to therapy. There are approximately 6.5 million dogs in the UK and 80 million in the US. Therefore, canine cancer represents a major healthcare problem for dogs, their owners and the veterinary practitioner.

Post-genome technologies have shown vast potential within the human healthcare sector towards the identification of biomarkers that can assist in the early detection of disease, and monitor its progression as well as its response to therapy (Ball et al., 2002. Bioinformatics, 18(3):395-404; Mian et al., 2003. Proteomics, 3(9):1725-1737; Mian et al., 2005. Journal of Clinical Oncology, 23(22):5088-5093; Rai et al., 2005. Proteomics, 5(13):3467-3474). Little attention, however, has been focused upon the application of post-genome technologies towards the veterinary sector, especially the study of canine related diseases and biomarker discovery. It is known that some canine diseases are commensurate with those seen within humans (eg cancer, renal disease and cardiac disease). As comparative models they have the following advantages: a) they provide naturally occurring diseased material for studying (as opposed to experimentally induced); and b) these pets live in the same environment as humans and are therefore exposed to the same aetiological agents of disease causation as their human counterparts. Biomarkers related to canine diseases may not only have direct relevance to the veterinary healthcare sector but could also be important markers of disease in human diseases (Lindblad-Toh et al., 2005. Nature, 438(7069):803-819; Sutter et al., 2007. Science, 316(5821):112-115).

Accordingly, the present invention seeks to identify biomarkers for use in the diagnosis of lymphoma in a canine subject and to provide diagnostic methods for the same.

The invention provides a method for identifying a biomarker(s) for diagnosis of lymphoma in a canine subject, the method comprising the following steps:
(i) providing serum samples from canine subjects with lymphoma (‘lymphoma samples’);
(ii) providing serum samples from canine subjects free from lymphoma (‘control samples’);
(iii) fractionating the protein components in the serum samples provided in steps (i) and (ii) using anion exchange chromatography;
(iv) further purifying proteins from the fractionated samples produced in step (iii) by contacting the proteins therein with a Surface-Enhanced Laser Desorption/Ionization (SELDI) protein chip comprising a cation exchange surface;
(v) characterising the proteins adhered to the cation exchange surface of the SELDI protein chip in step (iv) using mass spectrometry; and
(vi) performing a classification and regression tree (CART) analysis to identify proteins capable of acting as biomarkers for canine lymphoma, either alone or in combination with other proteins.

Steps (i) and (ii) comprise the provision of serum samples from canine subjects with and without lymphoma. Such samples may be collected and prepared using methods well known in the art (see Examples below).

In one embodiment, the serum samples in steps (i) and (ii) are chilled after collection (for example, stored at or around 4° C.) and prior to fractionation in step (iii). Thus, it is not necessary for the serum samples in steps (i) and (ii) to be frozen for storage prior to fractionation in step (iii).

In a further embodiment, the serum samples in steps (i) and (ii) are used in the methods of the invention within one month of collection from the canine subject.

Step (iii) comprises fractionating the protein components in the serum samples provided in steps (i) and (ii) using anion exchange chromatography. The anion exchange chromatography in step (iii) serves to fractionate albumin, immunoglobulin G and other ‘contaminating’ high level proteins from the serum samples into fractionated subsets (which may then be discarded). In one embodiment, the anion exchange chromatography in step (iii) may comprise the use of a Q ceramic Hyper D resin (available from Pall Corporation, US).

In a further embodiment, the anion exchange chromatography in step (iii) comprises elution of fractions using separate wash buffers, in order, having a pH of 9, 7, 5, 4, and 3, followed by an organic wash buffer. Conveniently, the fraction eluted at pH 3 is used in the further purification in step (iv).

Step (iv) comprises further purifying proteins from the fractionated samples produced in step (iii) by contacting the proteins therein with a SELDI protein chip comprising a cation exchange surface. In one embodiment, step (iv) comprises the use of a SELDI protein chip comprising a CM10 (carboxymethyl) cation exchange surface (available from Biorad Corporation, US).

In a further embodiment, the cation exchange surface is washed with a sodium acetate buffer (eg 100 mM) at pH 4 prior to loading samples of the fractions eluted from step (iii). Samples of the fractions eluted from step (iii) may be contacted with the cation exchange surface for 30 minutes at room temperature, prior to washing with a sodium acetate buffer (eg 100 mM) at pH 4.

Step (v) comprises characterising the proteins adhered to the cation exchange surface of the SELDI protein chip in step (iv) using mass spectrometry. In one embodiment, step (v) comprises mass spectrometry using mass acquisition between 0 and 200,000 Da, with a focus mass of 50,000 Da, a matrix attenuation of 1000 Da, sampling rate of 800 MHz with data acquisitions using a laser setting of 4000 nJ.

Step (v) comprises a data pre-processing sub-step including external mass calibration, normalisation (total ion content), baseline subtraction, noise reduction and/or peak extraction.

It will be appreciated that additional methods may also be used to characterise the proteins in the fractionated serum samples, such as protein gel electrophoresis using an SDS gel.

Step (vi) comprises performing a classification and regression tree (CART) analysis to identify proteins capable of acting as biomarkers, either alone or in combination with other proteins.

Such biomarkers for canine lymphoma may be identified in a number of ways. For example, a protein may serve as a biomarker if:
(a) the protein is present in the lymphoma samples and absent from the control samples;
(b) the protein is present in the lymphoma samples in a different amount relative to the control samples (either higher or lower, providing a difference in the relative amounts is detectable); or
(c) the protein is absent from the lymphoma samples and present in the control samples.

Furthermore, it will be appreciated that combinations of two or more proteins may serve as biomarkers. For example, the use of two or more biomarkers in combination may provide a greater degree of certainty in the diagnosis than use of such biomarkers in isolation. In an alternative scenario, the presence of hypothetical proteins X and Y may be indicative of canine lymphoma whereas the presence of either X or Y in the absence of the other protein may not be of diagnostic value.

In one embodiment, step (vi) comprises a CART analysis using the parameters identified in Table 1.

A related aspect of the invention provides the use of a biomarker identified or identifiable using a method as described above in the diagnosis of canine lymphoma.

In one embodiment, the biomarker has a mass spectral peak of an m/z value selected from the group consisting of 7014.2 Da, 74726 Da, 51110 Da, 8713.9 Da, 41789 Da, 93633 Da, 15229 Da, 5172.1 Da, 55315 Da and 161247 Da.

In particular, a biomarker having a mass spectral peak of an m/z value of 7014.2 Da or 74726 Da may be used.

As indicated above, multiple biomarkers identified or identifiable using a method as described above may be used in combination in the diagnosis of canine lymphoma. For example, biomarkers with a mass spectral peak of an m/z value of 7014.2 Da and 74726 Da may be used in combination in the diagnosis of canine lymphoma.

A further related aspect of the present invention provides a method for diagnosing lymphoma in a canine subject, the method comprising the following steps:
(i) providing a serum sample from a canine subject to be tested;
(ii) fractionating the protein components in the serum samples provided in step (i) using anion exchange chromatography;
(iii) further purifying proteins from the fractionated samples produced in step (ii) by contacting the proteins therein with a SELDI protein chip comprising a cation exchange surface; and
(iv) characterising the proteins adhered to the cation exchange surface of the SELDI protein chip in step (iii) using mass spectrometry.

Optionally, the method further comprises an additional step (v) of comparing the proteins identified in step (iv) with proteins present in serum samples from canine subjects free from lymphoma (‘control samples’).

In one embodiment, the serum samples in step (i) are chilled after collection (for example, stored at or around 4° C.) and prior to fractionation in step (ii). Thus, it is not necessary for the serum samples in step (i) to be frozen for storage prior to fractionation in step (ii).

In a further embodiment, the serum samples in step (i) are used in the methods of the invention within one month of collection from the canine subject.

Step (ii) comprises fractionating the protein components in the serum samples provided in step (i) using anion exchange chromatography. In one embodiment, the anion exchange chromatography in step (ii) fractionates albumin and immunoglobulin G within the serum samples (enabling its separation from other proteins of interest). For example, the anion exchange chromatography in step (ii) may comprise the use of a Q ceramic Hyper D resin (available from Pall Corporation, US).

In a further embodiment, the anion exchange chromatography in step (ii) comprises elution of fractions using separate wash buffers, in order, having a pH of 9, 7, 5, 4, and 3, followed by an organic wash buffer. Conveniently, the fraction eluted at pH 3 is used in the further purification in step (iii).

Step (iii) comprises further purifying proteins from the fractionated samples produced in step (ii) by contacting the proteins therein with a SELDI protein chip comprising a cation exchange surface. In one embodiment, step (iii) comprises the use of a SELDI protein chip comprising a CM10 (carboxymethyl) cation exchange surface (available from Biorad Corporation, US).

In one embodiment, the cation exchange surface is washed with a sodium acetate buffer (eg 100 mM) at pH 4 prior to loading samples of the fractions eluted from step (ii). Samples of the fractions eluted from step (ii) may be contacted with the cation exchange surface for 30 minutes at room temperature, prior to washing with a sodium acetate buffer (eg 100 mM) at pH 4.

Step (iv) comprises characterising the proteins adhered to the cation exchange surface of the SELDI protein chip in step (iii) using mass spectrometry. In one embodiment, step (iv) comprises mass spectrometry using mass acquisition between 0 and 200,000 Da, with a focus mass of 50,000 Da, a matrix attenuation of 1000 Da, sampling rate of 800 MHz with data acquisitions using a laser setting of 4000 nJ.

Step (iv) comprises a data pre-processing sub-step including external mass calibration, normalisation (total ion content), baseline subtraction, noise reduction and/or peak extraction.

In one embodiment, step (iv) comprises determining whether the serum sample from the subject to be tested comprises a biomarker having a mass spectral peak of an m/z value selected from the group consisting of 7014.2 Da, 74726 Da, 51110 Da, 8713.9 Da, 41789 Da, 93633 Da, 15229 Da, 5172.1 Da, 55315 Da and 161247 Da.

In particular, step (iv) may comprise determining whether the serum sample from the subject to be tested comprises a biomarker having has a mass spectral peak of an m/z value of 7014.2 Da and/or 74726 Da.

Conveniently, a positive diagnosis of lymphoma is made if the serum sample from the subject to be tested comprises biomarkers having has a mass spectral peak of an m/z value of 7014.2 Da and 74726 Da.

It will be appreciated that additional methods may also be used to characterise the proteins in the fractionated serum sample, such as protein gel electrophoresis using an SDS gel.

Preferred, non-limiting examples which embody certain aspects of the invention will now be described, with reference to the following figures:

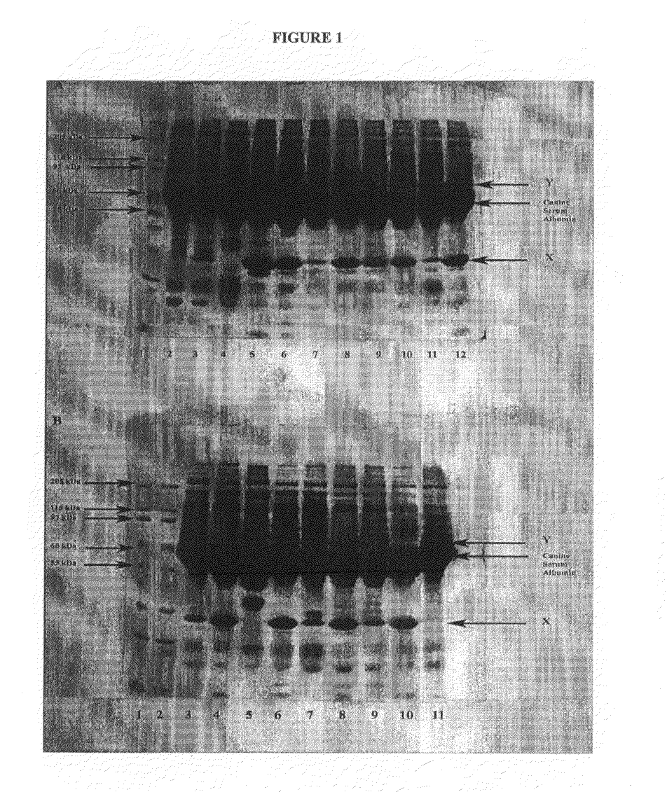

FIG. 1: Serum proteins taken from samples run on a 10% polyacrylamide gel.
(a) Lane 1 represents molecular weight standards. Lane 2 is a pooled serum sample frozen immediately after preparation. Lanes 3-12 are canine serum samples taken from patients that were maintained at 4° C. prior to testing. X and Y indicate possible degradation products not observed in the pooled sample frozen immediately after preparation.
(b) Lanes 1 and 2 are molecular weight standards. Lanes 3-10 are serum samples that were maintained at 4° C. prior to testing. Lane 11 indicates a pooled serum sample frozen immediately after preparation.

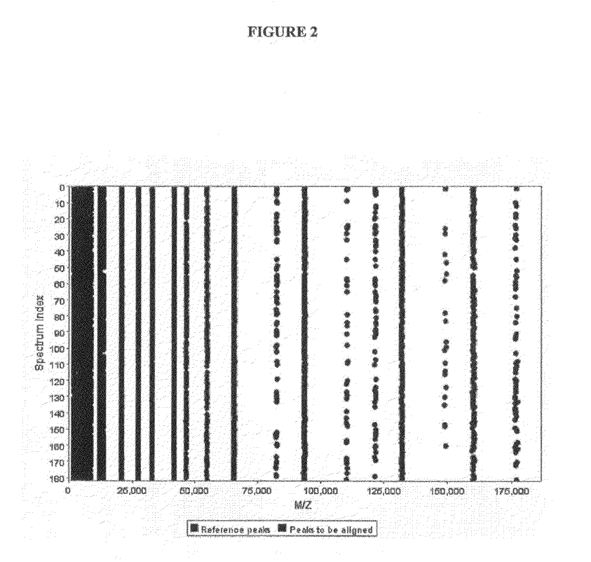

FIG. 2: A “dot plot' of the major peaks detected by SELDI mass spectrometry from fraction 5 (pH 3) eluted proteins from anion exchange.

Spectrum index (ie serum sample number) is given on the y-axis. Spectrum numbers 1 (control) and 2 (lymphoma) were frozen immediately following preparation. Spectrum numbers 3-181 were serum samples transported at 4° C. The x-axis represents the mass:charge ratio (ie mass of the detected peaks) within the fraction. The reference spectrum taken from a control serum sample frozen immediately after preparation is shown as the first sample (Spectrum Index=1) and was used as a control reference protein peak spectrum in which to compare peak stability in the chilled samples.

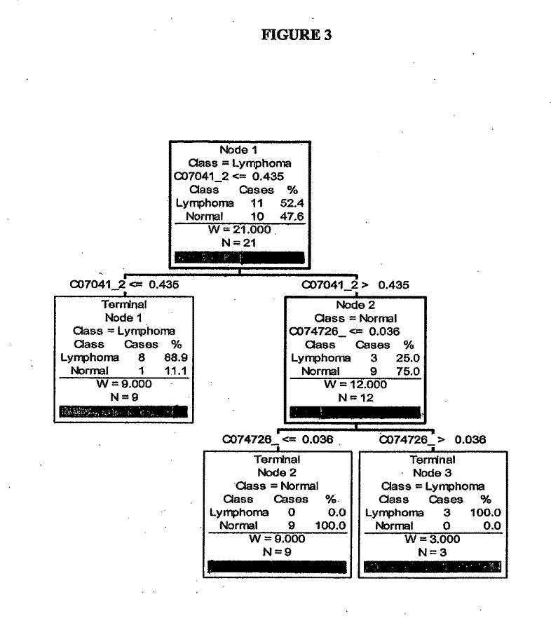

FIG. 3: The model produced by training the CART algorithm: Terminal and parent nodes used for classifying samples into control or lymphoma.

W=the number of samples that are currently present within the node (group); N=the number of samples actually assigned to child node (group). Parent nodes are highlighted in black and child nodes highlighted in grey. Parent nodes are further subdivided into child nodes with child nodes representing how samples are finally classified, ie control or lymphoma. The grey bar represents lymphoma patients. The black bar represents control patients.

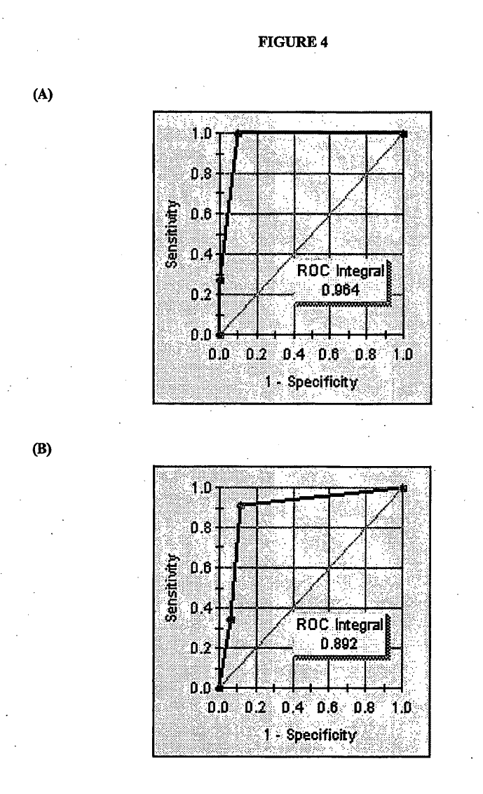

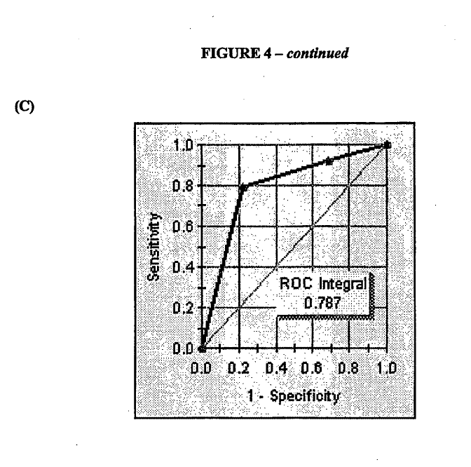

FIG. 4(a-c): Receiver Operator Characteristic (ROC) plots for lymphoma classification.
(a) ROC plot for the training dataset. Sensitivity values are plotted on the y-axis. 1-specificity values (false positives) are plotted on the x-axis.
(b) ROC plot for the first test dataset.
(c) ROC plot for test dataset 2.

### EXAMPLES

Materials and Methods

Patient Serum

Canine serum was collected as part of routine veterinary procedure from 14 separate veterinary centres across the USA. 6 centres provided control material and 11 centres donated serum derived from patients with diagnosed lymphoma. Material was collected as part of routine clinical procedure and full consent was given by owners for surplus material to be utilised for research and development. Patients were recruited on the basis of presentation to the clinical centres and hence were not biased towards any particular breed of dog. A total of 92 normal and 87 lymphoma patient serum samples (n=179) were used for the study. The normal cohort included patients with conditions such as generalised lymphadenopathy, mastocytosis and mild periodontal disease. The lymphoma patients were positively diagnosed through standard veterinary procedures eg pathological tissue biopsy. Blood was allowed to clot at room temperature for between 30 and 60 minutes, at which point the serum was separated from the cellular clot via centrifugation for 10 minutes at 2000 RPM. The serum samples were maintained at 4° C. from the point of removal until their pre-fractionation using anion exchange chromatography. Fractionated eluates were stored at −20° C. until mass spectrometry analysis.

Serum Fractionation Using Anion Exchange Chromatography

The process was conducted according to the manufacturer's instructions (Biorad Corporation, US). In summary, each well of a 96 well anion exchange fractionation plate (Biorad—Q ceramic hyper D plates) is re-suspended in 200 μl rehydration buffer (50 mM Tris, pH 9.0) and allowed to shake on a mixing plate (DPC—form 19, amplitude 7) for 60 minutes at room temperature. To 20 μl of canine serum, 30 μl of U9 buffer (50 mM Tris pH 9.0, 2% CHAPS, 9M Urea) is added. Sample and denaturing buffer are agitated on a micromix (DPC—form 19, amplitude 7) for 15 minutes to denature the proteins. Rehydration buffer is removed to waste and a fresh aliquot of 200 μl rehydration buffer is added to each well. The plate is agitated on a micromix (DPC—form 19, amplitude 7) for 5 minutes at room temperature. This step is repeated two times (total of three washes). 200 μl U1 buffer (U9 buffer diluted 1 in 9 with rehydration buffer) is added to each well of the fractionation plate and agitated on a micromix (form 19, amplitude 7) for 5 minutes at room temperature. This is removed to waste and this step repeated two more times to give a total of three washes with U1 buffer. Each denatured serum sample is added to the fractionation plate. 50 μl U1 buffer is added to each well of the V-bottomed plate and transferred to the corresponding sample in the fractionation plate. The fractionation plate is agitated for 30 minutes at room temperature. Unbound proteins are collected by placing the fractionation plate on the vacuum manifold for 60 seconds into a new microtitre plate. 100 μl of wash buffer 1 (50 mM Tris-HCL, 0.1% OGP, pH 9) is added to each well followed by agitation for five minutes at room temperature. This additional protein wash is added to the first fraction via the application of a vacuum. 100 μl Wash buffer 2 (50 mM Hepes, 0.1% OGP, pH 7) is added to each well of the fractionation plate and shaken (Form 19, Amp 7) for 5 minutes at room temperature. This fraction is collected to a new fractionation plate by placing on a vacuum manifold for 60 seconds. This step is repeated. Additional wash buffer extractions are conducted using wash buffer 3 (100 mM Sodium Acetate, 0.1% OGP pH 5), wash buffer 4 (100 mM sodium acetate, 0.1% OGP, pH 4), wash buffer 5 (50 mM sodium citrate, 0.1% OGP, pH 3) and finally wash buffer 6 (33.3% isopropanol, 16.7% acetonitrile, 0.1% trifluoroacetic acid). Samples are stored at −20° C.

Protein Gel Electrophoresis

Serum proteins were resolved using polyacrylamide gel electrophoresis. In brief, a stacking gel of 4% (w/v) polyacrylamide was used in conjunction with a resolving gel of 10% (w/v) polyacrylamide. An equal volume (10 μl) of serum and loading buffer (2×) were mixed together for 30 minutes at room temperature. 10 μg of total serum protein was loaded per gel lane. A Tris/glycine/SDS (0.025M Tris, 0.192M Glycine, 0.1% w/v SDS) running buffer was added to the tank and a voltage applied for 90 minutes. Gels were stained with Coomassie Blue.

SELDI Protein Chip Processing and Mass Spectrometry

CM10 chips (weak cation exchange surface [Biorad Corporation, US]) were assembled into a bioprocessor cassette. Samples (lymphoma and non-lymphoma counterparts) were randomized over the bioprocessor. Control pooled serum standards and molecular weight protein standards for calibration were also randomised over each array. For the fractionated serum samples 150 μl low stringency buffer (sodium acetate buffer, 100 mM, pH4) was added to each well, centrifuged (700 RPM for five minutes using an IEC Centra-8R) and incubated for five minutes at room temperature with agitation (amplitude 7, form 21). The buffer was removed to waste and the process repeated. To each well 90 μl of low stringency buffer was added followed by 10 μl serum fractionated eluate and the bioprocessor was centrifuged at 700 RPM for five minutes using an IEC Centra-8R. The sample was allowed to bind for 30 minutes at room temperature with agitation (amplitude 7, form 21) before being removed to waste. 150 μl low stringency buffer was applied to each well, washed for five minutes with agitation for a total of three times at which point 200 μl of water was applied to each well (two times) before air drying. Two 1 μl additions of sinipinic acid (10 mg ml⁻¹, diluted in 50% acetonitrile/0.05% TFA (trifluoro acetic acid)) were added to each spot.

Mass spectrometry analysis was conducted using a SELDI 4000 linear ToF (Time-of-Flight) instrument (Biorad, US). Mass acquisition occurred between 0-200,000 Daltons (Da), with a focus mass of 50,000 Da, matrix attenuation of 1000 Da, sampling rate of 800 MHz with 10 data acquisitions using a laser setting of 4000 nano-joules (nJ) preceded by two warming shots at 4400 nJ (these were not used for data analysis). A total of 25 acquisitions were made across the spot surface and these were averaged to form the final spectrum. Mass spectra were calibrated by external ToF equations and a series of known protein calibrants using a three point calibration equation to calibrate sample spectra. A coordinated series of data pre-processing steps were used to normalize mass spectral profiles and elucidate protein peaks that could be taken for downstream bioinformatic data mining. These pre-processing steps included baseline subtraction (smoothing the baseline before fitting), noise reduction (via the implementation of an averaging filter width and measuring noise from 1500 Da), data normalisation using total ion current (normalisation coefficient=0.2) and peak extraction.

Classification and Regression Tree (CART) Analysis

An initial cohort of protein peaks were identified from the pre-processing and peak extraction analysis. Peaks with p-values of ≦0.05 were taken for a final round of manual triaging. These resultant peaks were utilised for decision tree data model construction. Protein candidates from the fraction 5 (pH 3) cohorts were focused upon for bioinformatic algorithm development. 21 samples (10 normal and 11 lymphoma) were chosen at random to develop a CART algorithm. The remaining 158 samples were used as a blind test set to measure model performance. Through an iterative process the Biomarker Patterns Software (BPS) variable settings were modified in order to develop an accurate BPS classification model. This led to the examination of more than 50 models. Exploration of variable settings included, for example, the type of splitting function (eg Gini or Twoing), alteration of the Gini exponential function, whether single or combination biomarker variable settings would increase/decrease accuracy of classification, etc. The final model parameters used to develop this algorithm were based upon two key biomarkers and eight surrogate markers.

Results

Comparative Analysis of Serum Proteins Derived from Samples Transported at 4° C.

Patient serum samples were transported from US veterinary clinics to the UK using a commercially available chilled logistics service. Average transportation time taken for both control and lymphoma samples indicated that no significant difference in shipping time for either population was evident (Table 2). To assess how the protein profile of serum proteins frozen immediately after preparation compared to proteins derived from serum samples transported at 4° C., polyacrylamide gel electrophoresis was performed upon a random selection of serum samples (control and lymphoma) transported chilled versus a pooled serum sample frozen immediately after preparation (FIG. 1A and FIG. 1B). It can be observed that novel bands do appear within many of the chilled transported serum samples (bands X and Y) compared to non-chilled serum control samples. The presence of these bands is in strong contrast to the high level of protein band concordance (as observed through molecular weight comparison) seen between samples shipped at 4° C. and those frozen immediately.

Age of Dogs Providing Serum to the Study

The average age of lymphoma patients was 7.7 years (+/−2.6 years) and compares to an average age of 3.4 years (+/−3 years) for the control population (Table 3). While not statistically significant, this does represent an age bias for the lymphoma cohort. Assay performance in relation to the younger control patients will be addressed further.

Proteomic Analysis

Serum is highly complex and contains an abundance of proteins with varying dynamic ranges that can reach several orders of magnitude. Highly abundant proteins (eg serum albumin, IgG) have the potential to mask the presence of biomarkers and it is essential therefore to reduce the complexity of serum prior to mass spectral analysis. To reduce protein complexity serum samples were fractionated using anion exchange chromatography. Several protein fractions were eluted into buffers of pH 9, pH 7, pH 5, pH 4, pH 3 with a final organic wash. The samples were stored at −20° C. until mass spectrometric analysis was performed.

CM10 (carboxymethyl) cationic exchange surfaces were used as a second dimension of protein separation for each eluted fraction and samples were processed in two separate batches (Table 4). In order to confirm data derived from polyacrylamide gel analysis that protein molecular masses remain largely intact, a comparison of peaks detected from the pH 3 fraction using CM10 protein chips was performed. A signal to noise ratio of 2:1 was used to highlight some of the major protein peaks that could be detected within the pH 3 fraction (FIG. 2). A serum sample frozen immediately after removal from a normal donor patient (spectrum index number 1) is used as a reference spectrum to which all other samples were compared. The reference protein peaks from this sample are then used as a comparator to protein peaks detected in all other serum samples. This process facilitates easy visualisation for the presence/absence of protein peaks that are detected by mass spectrometry between all samples. Spectrum index number 2 was taken from a lymphoma patient that was frozen immediately after removal. Serum samples transported at 4° C. are shown by spectrum index numbers 3-181 (FIG. 2). There is a high degree of concordance between the peaks present in the frozen reference samples and the 4° C. transported serum samples and concurs with data derived from SDS-PAGE analysis (FIG. 1A and FIG. 1B). This may suggest therefore that in general protein stability is not adversely affected by chilled transportation.

Construction of CART Bioinformatic Algorithms Capable of Discriminating Lymphoma from Non-Lymphoma Patients

Data pre-processing was applied to the raw mass spectrometry data. These included external mass calibration, baseline subtraction, noise reduction, total ion current (TIC) normalisation and peak identification. Attention was focused upon the pH3 fraction and data parsing identified a total of 73 candidate peaks. Mann Whitney non-parametric U-testing was conducted to identify mass spectral peaks that had significantly different intensity values between the control and lymphoma populations. 39 were found to have p-values at the p≦0.05 level and these were further refined to 19 peaks by conducting a manual triage for true peaks as opposed to potential signals within noise.

Classification And Regression Tree (CART) bioinformatic algorithms were implemented in order to identify potential biomarkers (from the 19 peaks) that could correctly classify blind sample proteomic spectral data into either control or lymphoma groups. From the first cohort of 90 serum samples, 20% of the data (10 normal and 11 lymphoma serum samples (n=21)) were chosen at random to train the system. In order to develop an algorithm that would have excellent predictive capability for new datasets, an iterative process of trial and error was conducted to determine parameter settings enabling biomarkers with predictive capability to be identified (Table 1). Out of 19 candidate protein peaks, a final model was constructed using the intensity values from mass spectral peaks of m/z value 7041 Da and 74726 Da respectively. A further eight biomarkers were utilised as surrogate substitute biomarkers (Table 5).

The Tree Sequence of the final CART model is provided in FIG. 3. The first split of the population occurred using biomarker 7041 Da with a relative intensity value of ≦0.435 as a cut off point. This first split results in eight lymphoma samples and one control being moved to the left. This group of samples is classified as “Lymphoma” and results in the first terminal node. The remaining population of 12 samples were moved to the right for further classification. Application of biomarker peak 74726 Da in conjunction with a relative intensity value of ≦0.036 enabled the remaining nine normal samples and three lymphoma samples to be classified correctly, with the creation of terminal node 2 (“Normal”) and terminal node 3 (“Lymphoma”). The relative importance value attributed to each mass spectral peak is presented in Table 5 and is a measure of the relative contribution played towards the classification of samples. The results indicate that 11/11 (100%) lymphoma patients and 10/11 (90%) normal serum samples were correctly classified (Table 6). A Receiver Operator Characteristic (ROC) plot (a measure of the model's ability to discriminate true positives from false positives) for lymphoma classification gave an area under the curve of 0.964 (FIG. 4A), suggesting a high level of discrimination.

To test the model's ability to accurately predict on new blind sample data, the remaining 69 samples (35 lymphoma and 34 control) from the first batch of samples were presented to the trained CART algorithm and sensitivity and specificity values derived (Table 7). Sensitivity and specificity values of 91% and 88% respectively were obtained. ROC curves were plotted and an area under the curve value of 0.892 was obtained (FIG. 4B) indicative of excellent discriminatory power. The accuracy was determined to be 89.9% and positive predictive and negative predictive values of 88.9% and 90.9% respectively were obtained (the latter two values based upon a population presentation of 50:50 control to lymphoma patients). To test the robustness of the model further an additional 41 lymphoma and 48 normal samples were processed (batch2) and presented blindly to the algorithm for classification. Sensitivity and specificity values of 78% and 79% respectively were obtained indicating a strong maintenance of the model's ability to accurately distinguish normal from lymphoma patients (Table 8). ROC curves were plotted and an area under the curve value of 0.787 was obtained, indicating once again a strong ability to discriminate true from false positives (FIG. 4C).

Average Results for Test Set 1 and Test Set 2

A total of 158 blind samples (n=82 normal; n=76 lymphoma) were presented to the canine lymphoma classification algorithm via two separately processed batches. Sensitivity and specificity values for all lymphoma and control samples were calculated to be 84% and 83% respectively (Table 9). The positive predictive value (a measure of the algorithm's ability to discriminate true positives from false positives) was calculated to be 82%. The negative predictive value (a measure of the algorithm's ability to discriminate true negatives from false negatives) was calculated to be 85%. Both figures indicate excellent ability of the algorithm to discriminate true from false positives/negatives. The accuracy of prediction for the blind cohort 158 samples was 84%.

Normal Population Age Analysis

The mean age of the lymphoma patients compared to the control cohort was determined to be approximately two times greater. Although not statistically significant this did represent a clear age bias towards the older lymphoma patient cohort. To ensure that the system was not detecting age related as opposed to cancer associated biomarkers, attention was focused on the dogs from the normal population who were aged 5 or over (Table 10) and the accuracy of prediction for this group alone. The results show that for the sub-population of control dogs aged 5 or over (representing 25% of the control population) the average age was 7.82 years (+1-2.12 years). This is concordant with the average age of the lymphoma cohort. Next, the specificity value was calculated just for the sub-population and compared to average value for the total normal population. A specificity value of 83% was obtained and was consistent with the value (83%) obtained for the total population. This suggests therefore that model performance does not alter for the smaller proportion of older control animals and suggests that predictive capability is not biased towards the 75% of dogs with an age ≦5 ie the system is not identifying age related as opposed to lymphoma related biomarkers.

Discussion

Serum has been shown to be a highly useful clinical resource for the discovery of potential biomarkers of disease (Rai et al., 2005. Proteomics, 5(13):3467-3474; Anderson et al., 2002. Mol Cell Proteomics, 1(11):845-867; Oh et al., 2006. J Bioinform Comput Biol, 4(6):1159-1179; Zhang et al., 2004. Cancer Res, 64(16):5882-5890). The ease of access and preparation also make this biological material a highly attractive starting point in which to initiate biomarker discovery programmes. 179 serum samples (92 normal and 87 lymphoma) were fractionated using anion exchange chromatography with protein elution being carried out with buffers of pH ranging from pH 3 to pH 9. These fractions were analysed sequentially using SELDI CM10 cationic exchange protein chips and mass spectrometric analysis conducted from 0 to 200,000 Daltons. Using a series of data pre-processing steps to identify protein peaks (calibration, baseline subtraction, noise reduction, total ion current normalisation and peak extraction), 73 peaks were identified initially from the fraction 5 pH 3 eluted proteins. Mann Whitney U testing indicated that 39 of these peaks differed significantly at the p≦0.05 level and a manual triage refined these peaks down to a final 19 candidate proteins.

Supervised learning algorithms have the potential to identify biomarkers with predictive potential for new test sample data and a variety of computational approaches have been implemented in order to assist the discovery programme (Ball et al., 2002. Bioinformatics, 18(3):395-404; Oh et al., 2006. J Bioinform Comput Biol, 4(6):1159-1179; Tan et al., 2006. Proteomics, 6(23):6124-6133). These have included artificial neural networks, support vector machines, principal component analysis, decision trees etc. Each method has a variety of strengths and weaknesses in identifying biomarkers and as such computational approaches need to be implemented with a great deal of consideration. This study applied the use of CART as they can be trained to discriminate between populations eg normal and cancer, provide a mechanism to identify biomarkers of relevance and to rank the importance of any given biomarker to classification of samples.

A training set of 11 lymphoma and 10 normal serum proteomic profiles was utilised to develop a novel classification model for discriminating lymphoma from non-lymphoma patient profiles. A variety of model parameters had to be tested not only to identify key biomarker protein peaks but also to optimise the level of predictive performance for new blind data using the selected biomarker mass spectral peaks. Two key biomarkers of m/z value 7041 Da and 74726 Da were identified with discriminatory capabilities in addition to a further eight surrogate biomarker protein peaks. The model using these key biomarker mass values was then tested using a total of 158 blind samples (82 normal/76 lymphoma). Sensitivity and specificity were shown to be 84% and 83% respectively with a positive predictive value of 82% and a negative predictive value of 85%. Accuracy was calculated to be 84%. The data indicated a bias in age towards the lymphoma population compared to control cohort. Model performance was not affected by the bias of a higher proportion of younger dogs (75%) within the control population as shown by a specificity value of 83% for both the total population and the sub-population of control dogs whose age years.

In conclusion, the two exemplary biomarker mass values identified in this study in conjunction with the novel computational algorithm enable patient serum samples to be discriminated into either lymphoma or non-lymphoma classes. These markers in addition to the bioinformatic algorithm provide the foundation for the development of novel veterinary diagnostic assays, either in isolation (eg antibody based methodologies) or in combination, for the detection of lymphoma. These markers have relevance to monitoring response to therapy. Given the high level of similarity between canine diseases and human diseases, the relevance of these biomarkers towards the detection, treatment response and possible therapeutic application for human lymphoma is also noted.

TABLE 1
Parameter selection for the construction of decision tree classification
model.

| Conditions | Parameter |
|---|---|
| Set Focus: | Lymphoma |
| Automatic best predictor discovery: | Off |
| Number of predictors: | 19 |
| Categorical: | None |
| Auxillary factors: | None |
| Fraction of cases selected at random for | 0.8 |
| testing: | |
| Method: | BPS classification |
| Gini or twoing selection | Gini exponential selected |
| Favour even splits less factor: | 0.1 |
| Standard error rule | Minimum cost tree |
| Variable importance formula | All surrogates count equally |

TABLE 2
Transportation time of serum samples.

| | Average time | Standard deviation | |
|---|---|---|---|
| Sample type | (days) | (days) | Range (days) |
| Normal | 9.2 | 4 | 6-28 |
| Lymphoma | 8.2 | 4 | 3-29 |

The average transportation time taken from the point at which sample was removed

TABLE 3
Average age of dogs providing serum samples to either control or
lymphoma populations.

| Sample type | Average age (years) | Standard deviation (years) |
|---|---|---|
| Control | 3.4 | 3 |
| Lymphoma | 7.7 | 2.6 |

The average age of the dogs is shown with standard deviations.

TABLE 4
Sample numbers processed for each batch.

| Batch | Control (n) | Lymphoma (n) |
|---|---|---|
| 1 | 44 | 46 |
| 2 | 48 | 41 |

Serum samples for both control and lymphoma populations were processed in two consecutive batches. Numbers of samples from each cohort that were processed in batches 1 and 2 respectively are shown.

TABLE 5
Biomarker relative importance values.

| Biomarker m/z Value | Score | |
|---|---|---|
| C07041_2 | 100.00 | \|\|\|\|\|\|\|\|\|\|\|\|\|\|\|\|\|\|\|\|\|\|\|\|\|\|\|\|\|\|\|\|\|\|\|\|\|\|\|\|\|\| |
| C074726_{—} | 74.37 | \|\|\|\|\|\|\|\|\|\|\|\|\|\|\|\|\|\|\|\|\|\|\|\|\|\|\|\|\|\|\| |
| C051119_{—} | 49.85 | \|\|\|\|\|\|\|\|\|\|\|\|\|\|\|\|\|\|\|\| |
| C08713_9 | 43.50 | \|\|\|\|\|\|\|\|\|\|\|\|\|\|\|\|\|\| |
| C041789_{—} | 43.50 | \|\|\|\|\|\|\|\|\|\|\|\|\|\|\|\|\|\| |
| C093633_{—} | 30.74 | \|\|\|\|\|\|\|\|\|\|\|\| |
| C015229_{—} | 29.99 | \|\|\|\|\|\|\|\|\|\|\|\| |
| C05172_1 | 18.90 | \|\|\|\|\|\|\| |
| C055315_{—} | 18.90 | \|\|\|\|\|\|\| |
| C0161247 | 18.90 | \|\|\|\|\|\|\| |

The relative importance of each of the 10 biomarkers utilised to the classification of serum samples used to train the CART are provided. The first two biomarkers (m/z values 7041.2 Da and 74,726 Da) are used as the primary splitters while the other biomarkers represent surrogates biomarkers for additional redundancy within the model.

TABLE 6
Prediction success for training dataset.

| Actual | Total | Percent | Lymphoma | Normal |
|---|---|---|---|---|
| Class | Cases | Correct | N = 12 | N = 9 |
| Lymphoma | 11 | 100.000 | 11 | 0 |
| Control | 10 | 90.000 | 1 | 9 |

11 lymphoma and 10 control proteomic profiles were chosen at random as a training dataset for CART algorithms.
The “percent correct” figure for each population is shown in addition to a confusion matrix

TABLE 7
Predictive results for blind test set 1.

| | | | | | | | Positive | Negative | |
|---|---|---|---|---|---|---|---|---|---|
| Actual | Total | Percent | Lymphoma | Normal | Sensitivity | Specificity | Predictive | Predictive | Accuracy |
| Class | Cases | Correct | N = 36 | N = 33 | (%) | (%) | Value (%) | Value (%) | (%) |
| Lymphoma | 35 | 91.429 | 32 | 3 | 91 | 88 | 88.9 | 90.9 | 89.9 |
| Normal | 34 | 88.235 | 4 | 30 | | | | | |

35 lymphoma and 34 control proteomic profiles were presented blindly to the trained algorithm to test model performance. A “percent correct” figure for each population is shown in addition to a confusion matrix. Calculation of sensitivity and specificity was as follows: sensitivity = TP/TP + FN; specificity = TN/TN + FP where TP = True Positive, TN = True Negative, FP = False positive and FN = False negative. Positive predictive value is defined as TP = TP/TP + FP and negative predictive value is defined as TN = TN/TN + FN. These final figures are indicative of a presentation of approximately 50:50 control to lymphoma samples respectively to the trained algorithm. Accuracy of prediction is defined as TP + TN/TP + TN + FN + FP.

TABLE 8
Predictive results for blind test set 2.

| | | | | | | | Positive | Negative | |
|---|---|---|---|---|---|---|---|---|---|
| Actual | Total | Percent | Lymphoma | Normal | Sensitivity | Specificity | Predictive | Predictive | Accuracy |
| Class | Cases | Correct | N = 42 | N = 47 | (%) | (%) | Value (%) | Value (%) | (%) |
| Lymphoma | 41 | 78.049 | 32 | 9 | 78 | 79 | 76 | 80.9 | 78.7 |
| Normal | 48 | 79.167 | 10 | 38 | | | | | |

41 lymphoma and 48 control proteomic profiles were presented blindly to the trained algorithm to test model performance. A “percent correct” figure for each population is shown in addition to a confusion matrix. Calculation of sensitivity and specificity was as follows: sensitivity = TP/TP + FN; specificity = TN/TN + FP where TP = True Positive, TN = True Negative, FP = False positive and FN = False negative. Positive predictive value is defined as TP = TP/TP + FP and negative predictive value is defined as TN = TN/TN + FN. These final figures are indicative of a presentation of approximately 50:50 control to lymphoma samples respectively to the trained algorithm. Accuracy of prediction is defined as TP + TN/TP + TN + FN + FP.

TABLE 9
Prediction success for all test data samples.

| | | | | | | | Positive | Negative | |
|---|---|---|---|---|---|---|---|---|---|
| Actual | All | Percent | Lymphoma | Normal | Sensitivity | Specificity | Predictive | Predictive | Accuracy |
| Class | Cases | Correct | N = 78 | N = 80 | (%) | (%) | Value (%) | Value (%) | (%) |
| Lymphoma | 76 | 84 | 64 | 12 | 84 | 83 | 82 | 85 | 84 |
| Normal | 82 | 83 | 14 | 68 | | | | | |

76 lymphoma and 82 control proteomic profiles were presented blindly to the trained algorithm to test model performance. A “percent correct” figure for each population is shown in addition to a confusion matrix. Calculation of sensitivity and specificity was as follows: sensitivity = TP/TP + FN; specificity = TN/TN + FP where TP = True Positive, TN = True Negative, FP = False positive and FN = False negative. Positive predictive value is defined as TP = TP/TP + FP and negative predictive value is defined as TN = TN/TN + FN. These final figures are indicative of a presentation of approximately 50:50 control to lymphoma samples respectively to the trained algorithm. Accuracy of prediction is defined as TP + TN/TP + TN + FN + FP.

TABLE 10
Results of assay performance to correctly predict controls with an
age ≧5 compared to the total normal control population.

| Parameter | Value |
|---|---|
| Number of dogs in the sub | 23 |
| population with an age ≧5 | |
| Total number of dogs in control | 92 |
| population | |
| Average age (years) | 7.82 (+/−2.12) [7.7 +/− 2.6] |
| Proportion of normal population with | 25% (23/92) |
| an age ≧5 | |
| Percentage of control population with | 83% (19/23) |
| an age ≧5 that were accurately | [83% specificity for total] |
| predicted | |

Values shown in red for “Average age” indicate the average age for the lymphoma group (+/−standard deviation).
The figure shown in bold red for “Percentage of control population with an age ≧5 that were accurately predicted” indicates the specificity value obtained for the total control population.

1. A method for identifying a biomarker for diagnosis of lymphoma in a canine subject, the method comprising the following steps:
(i) providing serum samples from canine subjects with lymphoma (‘lymphoma samples’);
(ii) providing serum samples from canine subjects free from lymphoma (‘control samples’);
(iii) fractionating the protein components in the serum samples provided in steps (i) and (ii) using anion exchange chromatography;
(iv) further purifying proteins from the fractionated samples produced in step (iii) by contacting the proteins therein with a Surface-Enhanced Laser Desorption/Ionization (SELDI) protein chip comprising a cation exchange surface;
(v) characterising the proteins adhered to the cation exchange surface of the SELDI protein chip in step (iv) using mass spectrometry; and
(vi) performing a classification and regression tree (CART) analysis to identify proteins capable of acting as biomarkers, either alone or in combination with other proteins.
wherein the serum samples in steps (i) and (ii) are stored chilled and not frozen prior to fractionation in step (iii).

2. A method according to claim 1, wherein the anion exchange chromatography in step (iii) fractionates albumin and immunoglobulin G present in the serum samples.

3. A method according to claim 1, wherein the anion exchange chromatography in step (iii) comprises the use of a Q ceramic Hyper D resin.

4. A method according to claim 1, wherein the anion exchange chromatography in step (iii) comprises elution of fractions using separate wash buffers, in order, having a pH of 9, 7, 5, 4, and 3, followed by an organic wash buffer.

5. A method according to claim 4, wherein the fraction eluted at pH 3 is used in the further purification in step (iv).

6. A method according to claim 1, wherein step (iv) comprises the use of a SELDI protein chip comprising a CM 10 (carboxymethyl) cation exchange surface.

7. A method according to claim 1, wherein the cation exchange surface is washed with a sodium acetate buffer at pH 4 prior to loading samples of the fractions eluted from step (iii).

8. A method according to claim 1, wherein step (iv) comprises contacting the samples of the fractions eluted from step (iii) with the cation exchange surface for 30-minutes at room temperature, prior to washing with a sodium acetate buffer at pH 4.

9. A method according to claim 1, wherein step (v) comprises mass spectrometry using mass acquisition between 0 and 200,000 Da, with a focus mass of 50,000 Da, a matrix attenuation of 1000 Da, sampling rate of 800 MHz with data acquisitions using a laser setting of 4000 nJ.

10. A method according to claim 1, wherein step (v) comprises data pre-processing including external mass calibration, normalisation (total ion content), baseline subtraction, noise reduction and/or peak extraction.

11. A method according to claim 1, wherein step (vi) comprises a CART analysis using the parameters identified in Table 1.

12-16. (canceled)

17. A method for diagnosing lymphoma in a canine subject, the method comprising the following steps:
i. providing a serum sample from a canine subject to be tested;
ii. fractionating the protein components in the serum sample provided in step (i) using anion exchange chromatography;
iii. further purifying proteins from the fractionated samples produced in step (ii) by contacting the proteins therein with a SELDI protein chip comprising a cation exchange surface; and
iv. characterising the proteins adhered to the cation exchange surface of the SELDI protein chip in step (iii) using mass spectrometry.
wherein the serum sample in step (i) is stored chilled and not frozen prior to fractionation in step (ii).

18. A method according to claim 17, further comprising step (v) of comparing the proteins identified in step (iv) with proteins present in serum samples from canine subjects not previously diagnosed with lymphoma (‘control samples’).

19. A method according to claim 17, wherein the anion exchange chromatography in step (ii) fractionates albumin and immunoglobulin G present in the serum samples.

20. A method according to claim 17, wherein the anion exchange chromatography in step (ii) comprises the use of a Q ceramic Hyper D resin (Pall Corporation, US).

21. A method according to claim 17, wherein the anion exchange chromatography in step (ii) comprises elution of fractions using separate wash buffers, in order, having a pH of 9, 7, 5, 4, and 3, followed by an organic wash buffer.

22. A method according to claim 21, wherein the fraction eluted at pH 3 is used in the further purification in step (iii).

23. A method according to claim 17, wherein step (iii) comprises the use of a SELDI protein chip comprising a CM10 (carboxymethyl) cation exchange surface.

24. A method according to claim 23, wherein the cation exchange surface is washed with a sodium acetate buffer at pH 4 prior to loading samples of the fractions eluted from step (ii).

25. A method according to claim 17, wherein step (iii) comprises contacting the samples of the fractions eluted from step (ii) with the cation exchange surface for 30-minutes at room temperature, prior to washing with a sodium acetate buffer at pH 4.

26. A method according to claim 17, wherein step (iv) comprises mass spectrometry using mass acquisition between 0 and 200,000 Da, with a focus mass of 50,000 Da, a matrix attenuation of 1000 Da, sampling rate of 800 MHz with data acquisitions using a laser setting of 4000 nJ.

27. A method according to claim 17, wherein step (iv) comprises data pre-processing including external mass calibration, normalisation (total ion content), baseline subtraction, noise reduction and/or peak extraction.

28. A method according to claim 17, wherein step (iv) comprises determining whether the serum sample from the subject to be tested comprises a biomarker having a mass spectral peak of an m/z value selected from the group consisting of 7041.2 Da, 74726 Da, 51119 Da, 8713.9 Da, 41789 Da, 93633 Da, 15229 Da, 5172.1 Da, 55315 Da and 161247 Da when identified by a method according to claim 17 in which step (iii) comprises the use of a SELDI protein chip comprising a CM10 (carboxymethyl) cation exchange surface, the cation exchange surface is washed with a sodium acetate buffer at pH 4 prior to loading samples of the fractions eluted from step (ii), step (iii) comprises contacting the samples of the fractions eluted from step (ii) with the cation exchange surface for 30-minutes at room temperature, prior to washing with a sodium acetate buffer at pH 4, and step (iv) comprises mass spectrometry using mass acquisition between 0 and 200,000 Da, with a focus mass of 50,000 Da, a matrix attenuation of 1000 Da, sampling rate of 800 MHz with data acquisitions using a laser setting of 4000 nJ.

29. A method according to claim 28, further comprising determining whether the serum sample from the subject to be tested comprises a biomarker having a mass spectral peak of an m/z value of 7041.2 Da and/or 74726 Da.

30. A method according to claim 17, wherein a positive diagnosis of lymphoma is made if the serum sample from the subject to be tested comprises biomarkers having a mass spectral peak of an m/z value of 7041.2 Da and 74726 Da.

31. A method for diagnosing lymphoma in a canine subject, the method comprising the following steps:
(i) providing a serum sample from a canine subject to be tested; and
(ii) determining the presence and/or amount in the serum sample of at least one biomarker having a mass spectral peak of an m/z value selected from the group consisting of 7041.2 Da, 74726 Da, 51119 Da, 8713.9 Da, 41789 Da, 93633 Da, 15229 Da, 5172.1 Da, 55315 Da and 161247 Da.

32. A method according to claim 31, wherein the at least one biomarker has a mass spectral peak of an m/z value of 7041.2 Da or 74726 Da.

33. A method according to claim 31, wherein the at least one biomarker has a mass spectral peak of an m/z value of 7041.2 Da.

34. A method according to claim 31, wherein the at least one biomarker has a mass spectral peak of an m/z value of 74726 Da.

35. A method according to claim 31, wherein biomarkers with a mass spectral peak of an m/z value of 7041.2 Da and 74726 Da are used in combination in the diagnosis of canine lymphoma.

36. A method according to claim 31, wherein step (ii) comprises
(a) fractionating protein components in the serum sample provided in step (i) using anion exchange chromatography;
(b) further purifying proteins from the fractionated samples produced in step (a) by contacting the proteins therein with a SELDI protein chip comprising a cation exchange surface; and
(c) characterising the proteins adhered to the cation exchange surface of the SELDI protein chip in step (b) using mass spectrometry.

37. A method according to claim 36, wherein the anion exchange chromatography in step (a) fractionates albumin and immunoglobulin G present in the serum samples.

38. A method according to claim 36, wherein the anion exchange chromatography in step (b) comprises elution of fractions using separate wash buffers, in order, having a pH of 9, 7, 5, 4, and 3, followed by an organic wash buffer.

39. A method according to claim 38, wherein the fraction eluted at pH 3 is used in the further purification in step (b).

40. A method according to claim 36, wherein step (b) comprises the use of a SELDI protein chip comprising a CM10 (carboxymethyl) cation exchange surface.

41. A method according to claim 40, wherein the cation exchange surface is washed with a sodium acetate buffer at pH 4 prior to loading samples of the fractions eluted from step (a).

42. A method according to claim 36, wherein step (b) comprises contacting the samples of the fractions eluted from step (a) with the cation exchange surface for 30-minutes at room temperature, prior to washing with a sodium acetate buffer at pH 4.

43. A method according to claim 36, wherein step (c) comprises mass spectrometry using mass acquisition between 0 and 200,000 Da, with a focus mass of 50,000 Da, a matrix attenuation of 1000 Da, sampling rate of 800 MHz with data acquisitions using a laser setting of 4000 nJ.
